(19) United States
(12) Patent Application Publication
(10) Pub. No.: US 2005/0200040 A1
(43) Pub. Date: Sep. 15, 2005

(54) Method of preparing membrane electrode assemblies with aerogel supported catalyst

(76) Inventors: Hiroaki S. Hara, West Hartford, CT (US); Alevtina Smirnova, Mansfield Center, CT (US)

Correspondence Address: McCormick, Paulding & Huber LLP, CityPlace II, 185 Asylum Street, Hartford, CT, 06103, US

(21) Appl. No.: 10/800,993

(22) Filed: Mar. 15, 2004

(51) Int. Cl. B29C 41/02

(52) U.S. Cl. 264/104; 264/140; 264/349; 264/308; 156/230

(57) ABSTRACT

A process of manufacturing a membrane electrode assembly comprises the steps of preparing an electrode-forming catalyst ink comprising porous aerogel supported catalyst and an electrolyte; depositing the prepared catalyst ink on a polymer film to form one or more catalyst layers; hot-pressing the one or more catalyst layers deposited on the polymer film at a temperature that is higher than a glass transition temperature of the electrolyte; decreasing the temperature of the hot-pressed catalyst layer and the polymer film; and removing the polymer film from the one or more catalyst layers.

### TECHNICAL FIELD

This invention relates generally to polymer electrolyte membrane fuel cells, and, more particularly, to a method of making electrodes with aerogel supported catalysts in combination with membrane electrode assemblies.

### BACKGROUND OF THE INVENTION

Various types of fuel cells have been proposed for applications such as electrical vehicles, power plants, and the like. One type of fuel cell uses a polymer electrolyte membrane that has the ability to conduct hydrogen therethrough to provide for ion exchange. The ion exchange is effected between electrodes (an anode and a cathode) positioned on the membrane. The electrodes are formed of conductive materials such as carbon having metal particles deposited on the surface thereof. In the operation of the fuel cell, gas and/or liquid fuel (e.g., hydrogen, alcohol, and the like) is supplied to the anode, and an oxidant (e.g., oxygen or air) is supplied to the cathode. The ion exchange across the electrodes provides energy to a load connected to the fuel cell. A water by-product is also produced.

One type of electrode is a carbon-supported metal catalyst. The carbon-supported metal catalyst comprises carbon spherical particles on which metal particles are deposited. The electrode may be deposited on the polymer electrolyte membrane as a catalyst ink. Preparation of such catalyst ink includes mixing the catalyst with the hydrogen conducting polymer electrolyte and homogenizing the resultant mixture. During this process, agglomeration of the catalyst particles takes place. This agglomeration often contributes to subsequent sintering of the metal during operation of the fuel cell, uneven distribution of the polymer electrolyte relative to the carbon spheres of the catalyst metal particles, and permeability of the reactants at the three-phase boundary.

On the microscale level, this means that the distribution of polymer electrolyte in the catalyst layer has an unpredictable variation in thickness around and between the supported metal particles. Under high currents and in the presence of oxidizing or reducing atmospheres, the desirable properties can be diminished.

A further redistribution of phases could occur further with time due to the difference in electrochemical potentials and local currents, which could result in the internal delamination of the polymer from the surface of the catalyst particles. In the case of natural agglomeration, delamination cannot be avoided even by accurate pH adjustment. This problem has been partially solved by utilizing a carbon support having a smaller pore volume on the surface of the carbon primary particles so as to decrease the number of metal particles adsorbed in the small pores where the polymer electrolyte generally cannot penetrate. However, this pore volume is generally still too big, and, as a result, adsorption of the metal may still occur, thereby limiting the availability of the adsorbed metal available for the electrolyte.

In the case of agglomeration that cannot be avoided in the process of ink preparation using a typical commercial catalyst, about 40% of the metal particles are not available for use in the polymer electrolyte. Therefore, about 40% of the metal particles do not participate in the necessary catalytic reaction. Furthermore, another problem with prior art catalysts in syntheses of these types of catalysts is the generation of various catalyst poisoning species.

What is needed is a method of providing a fuel cell with aerogel-supported layers having a sufficiently dimensioned and reproducible microstructure.

### SUMMARY OF THE INVENTION

A method of providing a fuel cell with aerogel-supported layers having reproducible microstructure allows for the substantially uniform penetration of the polymer electrolyte inside the pores of a supporting aerogel and for improved utilization of the catalyst. In particular, such a method limits the restriction of the agglomeration process and provides a better oxygen transport to the catalyst sites due to the substantially uniform thickness of the electrolyte inside the pores of the catalyst.

The structure of aerogel-supported catalyst used in the present invention has a substantially even and reproducible pore size distribution. The metal particles attached to the inner surface of the aerogel pores are, furthermore, of a substantially even size in terms of size distribution and are substantially reproducible. The size of the pores can be changed during synthesis for the accommodation of electrolyte molecules of varying sizes. Once deposited inside the pores of the aerogel, the molecule of the electrolyte is trapped, and the metal particles in the pores are substantially uniformly covered by the polymer and are able to participate in an electrochemical reaction. Because of the substantially uniform covering, sintering of the metal particles is reduced. Different conditions of syntheses of the aerogel also allow for the adjustment of the size of the pores to the size of the polymer molecule to avoid de-localization of the metal particles on the nano-scale level and to improve long-term stability and cell performance.

In one aspect of the present invention, a process of manufacturing a membrane electrode assembly comprises the steps of preparing an electrode-forming catalyst ink comprising a porous aerogel supported catalyst and an electrolyte; depositing the prepared catalyst ink on an inert polymer film (e.g., a decal support) to form one or more catalyst layers; hot-pressing the one or more catalyst layers to be deposited on the polymer electrolyte film at a temperature that is higher than a glass transition temperature of the electrolyte; decreasing the temperature of the hot-pressed catalyst layer and the polymer film; and removing the inert polymer film (e.g., the decal support) from the one or more catalyst layers.

In another aspect of the present invention, a process of preparing a membrane electrode assembly for use in a fuel cell comprises preparing a decal having a catalyst ink deposited thereon and transferring the catalyst ink from the decal to a membrane of the membrane electrode assembly to form an electrode. The preparation of the decal may include depositing the catalyst ink on a polymer film. The transferring of the catalyst ink may include placing the decal on the membrane and hot-pressing the decal against the membrane.

In yet another aspect of the present invention, a process of preparing an electrode-forming catalyst ink for use in a membrane electrode assembly of a fuel cell comprises grinding a porous carbon aerogel having a metal disposed thereon, grinding an electrolyte material, and homogenizing the ground porous carbon aerogel and the ground electrolyte material. The porous carbon aerogel and the electrolyte material may be ground individually and combined, or they may be combined and ground in one grinding operation. The process may further include the application of the catalyst ink to an inert polymer film. The application may be by screen printing the ink onto the inert polymer film, spraying the ink onto the inert polymer film, depositing the ink onto the inert polymer film using a micro-gravure technique, sputtering the ink onto the inert polymer film, spin-coating the ink onto the inert polymer film, or a combination thereof.

One advantage to the above-described invention is derived from the use of aerogels themselves. Aerogel materials possess a wide variety of exceptional properties that allow for their chemical synthesis to be controlled. In particular, it should be noted that while the pore sizes of common carbons used as supports for PEMFC catalysts cannot be altered, the pore sizes of aerogels can be altered. The porosity can also be manipulated to produce a desired structure. Furthermore, the porosity of the aerogel can be modified via chemical synthesis with further distribution of metallic particles to optimize the contact of the aerogel with an ion conducting polymer electrolyte.

Another advantage is that manufacture of membrane electrode assemblies (MEAs) by the above-described method provides superior performance over MEAs produced by other methods. The superior performance provided by the method may be due in part to a marked increase in adsorption energy of the catalyst/aerogel particles and the rate of oxygen reduction reaction. Such an increase in energy and rate of oxygen reduction reaction may be attributable to the smaller size of the platinum particles on the surface of the aerogel in comparison to other commercially available catalysts.

Another reason for the superior performance exhibited by MEAs manufactured by the above-described method is the result of the pore size distribution of the carbon aerogel support. The pore size distribution of carbon supported platinum aerogels used in the above-described method is narrow in comparison with pore size distributions of other carbon supported catalysts. Such a narrow pore size distribution is favorable for long-chain polymer electrolyte molecules, as described herein, which can penetrate the pores of the carbon aerogel and significantly increase the electrochemical surface area of the catalyst and the oxygen reduction reaction kinetics.

### BRIEF DESCRIPTION OF THE DRAWINGS

FIG. 1 is a schematic representation of the nano-structure of a catalyst layer based on a carbon-supported catalyst.

FIG. 2 is a schematic representation of the nano-structure of a catalyst layer based on an aerogel supported catalyst.

FIG. 3 is an exploded schematic representation of a fuel cell.

FIG. 4 is a cross sectional representation of a membrane electrode assembly of a fuel cell.

FIG. 5 is a an image of aerogel-supported platinum catalyst.

FIG. 6 are high resolution TEM images of aerogel supported platinum catalyst.

FIG. 7 is a cyclic voltammetry plot for an aerogel-supported platinum catalyst with 25% ionomer before and after humidification.

FIG. 8 is a cyclic voltammetry plot for an unsupported platinum catalyst with 10% ionomer in a cathode catalyst layer before and after humidification.

FIG. 9 is a cyclic voltammetry plot for a carbon supported commercial platinum catalyst.

FIG. 10 is a cyclic voltammetry plot for an aerogel-supported platinum catalyst at various catalyst loadings after humidification.

FIG. 11 is a cyclic voltammetry plot for commercial carbon-supported platinum catalyst at various catalyst loadings.

FIG. 12 is a cyclic voltammetry plot of data for aerogel-supported catalysts at various times.

FIG. 13 is a graphical representation illustrating the change in voltage over varying current density for MEAs having varying platinum loadings in an oxygen atmosphere.

FIG. 14 is a graphical representation illustrating the change in voltage over varying current density for MEAs having varying platinum loadings in air.

FIG. 15 is a graphical representation of PEMFC performance with aerogel-supported platinum cathode at various operating conditions in an air/hydrogen environment.

### DETAILED DESCRIPTION OF THE PREFERRED EMBODIMENT

Disclosed herein are carbon aerogels and metallic compositions thereof for use in fuel cell applications. Also disclosed herein are methods of preparing membrane electrode assemblies using aerogel-supported catalysts.

Aerogels may be either inorganic (e.g., silica-, alumina-, titania-, vanadia-, niobia-, zirconia-, or tantala-based) or organic (e.g., derived from organic constituents). Silica-based inorganic aerogels are typically derived using precursors or monomers such as tetramethyl orthosilicate (TMOS, Si(OCH₃)₄), tetraethyl orthosilicate (TEOS, Si(OCH₂CH₃)₄), combinations of the foregoing orthosilicates, or the like. Organic aerogels (particularly RF aerogels) may be pyrolized to form carbon-based aerogels. As used herein, the term “aerogel” is intended to indicate all aerogel forms including, but not limited to, inorganic aerogels, organic aerogels (particularly carbon aerogels), and xerogels (gels formed when hydrogels are air dried as opposed to supercritically dried).

Organic aerogels may be produced by the reaction of any one or a combination of various monomers in an appropriate ratio with formaldehyde, furfural, or the like in the presence of a catalyst via a polymerization reaction (e.g., a polycondensation reaction). The monomer(s) is preferably a polyhydroxybenzene compound, exemplary embodiments of which include, but are not limited to, resorcinol, phenol, catechol, chloroglucinal, combinations thereof, and the like. Reaction of such monomers with formaldehyde or furfural generally produce, for example, resorcinol-furfural, resorcinol-formaldehyde, phenol-resorcinol-formaldehyde, catechol-formaldehyde, chloroglucinol-formaldehyde, or the like.

In one exemplary polymerization reaction to form an organic aerogel, the reactants (i.e., the monomers) are mixed with the catalyst to produce the aerogel in the form of a monolithic gel, which is then dried by solvent exchange and extraction. The resulting organic aerogel is then pyrolized in an inert atmosphere (e.g., nitrogen) to form the carbon aerogel. More specifically, the polymerization reaction is a sol-gel polymerization of multifunctional organic monomers in a solvent (e.g., water). The sol-gel polymerization leads to the formation of highly cross-linked, transparent or translucent gels (referred to hereinafter as “hydrogel sols”). A metal may also be added with the monomers, thereby forming an aerogel/metallic composition.

One exemplary method of making an aerogel/metallic composition comprises contacting an aerogel with a supercritical fluid comprising a metallic compound. The concentration of the metallic compound should be sufficient to provide the desired amount of the metallic particle dispersed within the aerogel. In another method of making an aerogel/metallic composition, the metallic compound can be added along with the reactants, e.g., monomers, in the preparation of the hydrogel sol. This can be conducted in addition to, or instead of, the contacting of the aerogel with a supercritical fluid comprising a metallic compound. In still yet another aspect of making a metallic aerogel composition, the metallic particle can be impregnated into the surface of the aerogel.

Regardless of their method of preparation, aerogel/metallic compositions can be used with the metal present in an ionic state or in the free metal state. If the free metal state is desired, the metal in ionic form can be reduced by any method known to those skilled in the art, for example, by conducting a second thermolysis step, for example, at a temperature of about 200 degrees C. to about 600 degrees C. Preferably, particles comprising the metal have a surface area of at least about 50 m²/g, preferably at least about 100 m²/g, more preferably at least about 200 m²/g, and most preferably at least about 300 m²/g.

Preferably, the metal used in an aerogel/metallic composition is one or more particlized metals, one of which may be a transition metal, and more preferably which is particlized platinum in an oxidized state evenly distributed on the surface of a carbon aerogel support. The size of the particles are about 1 nanometer (nm) to about 2.5 nm in diameter and preferably about 1 nm.

As in all catalysis reactions, the catalyst directly in contact with an electrolyte has the ability and, therefore, the most opportunity for participation in the reaction. One factor in influencing the performance of a fuel cell into which the catalyst is incorporated is the electrochemical surface area (ESA) of the catalyst. Electrolyte molecules penetrating the pores of the aerogel structure, swelling as a result of humidification, and thereby improving the contact between the electrolyte and the catalyst particles, thus increase the ESA of the catalyst. Humidification is typically effected at about 80 degrees C., so as to provide for significant increase in the volume of the electrolyte.

Referring to FIG. 1, a schematic diagram of the nano-structure of the catalyst layer based on a carbon supported catalyst is shown generally at 10. In the nano-structure 10, metal (e.g., platinum) particles 12, 13 are located on the surface of a carbon support 14 and are agglomerated as a result of an ink preparation procedure and structure of the catalyst. Pores 16, due to their small size d, are not filled with polymer electrolyte upon contacting the carbon support 14 with a conductive polymer electrolyte 18. Consequently, the particles 12 will not participate in a catalytic reaction while the particles 13, which are positioned on the carbon support 14 so as to be in contact with the conductive polymer electrolyte 18, will participate in a catalytic reaction. The thickness of an electrolyte layer is uneven and is determined mainly by the probable distribution of the carbon particles of the carbon support 14 during preparation of the catalyst ink.

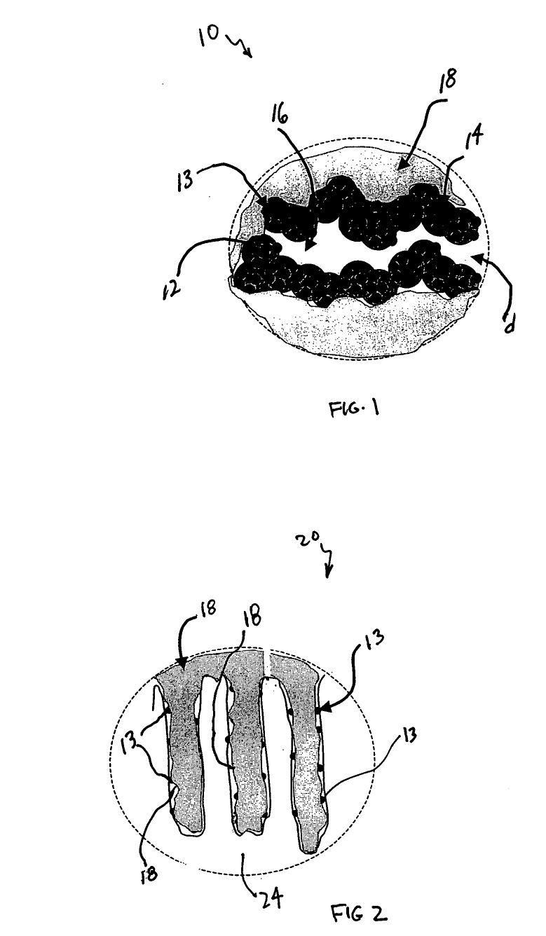

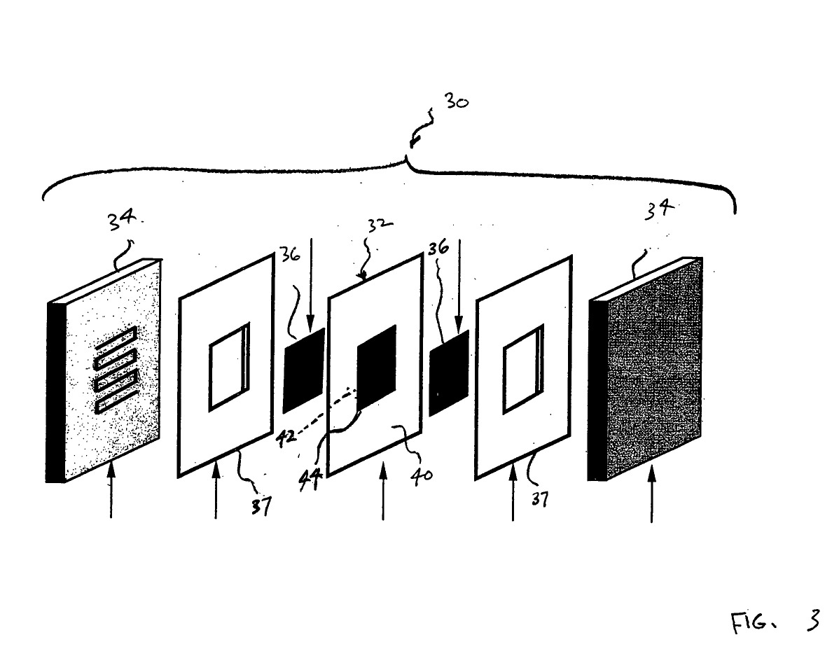

Referring now to FIG. 2, a schematic diagram of the aerogel supported catalyst with metal (e.g., platinum) particles located on the inside surface of the aerogel pores is shown generally at 20. The conductive polymer 18 penetrates the pores of the aerogel 24. A high percentage of the platinum particles 13 disposed inside the pores of the aerogel 24 are in contact with the conductive polymer electrolyte 18 and are, therefore, active. The thickness of the electrolyte layer is fixed by the size of the pores, and an even pore size distribution is realized to allow for higher utilization of the catalyst.

Particular forms of the aerogel/metallic compositions include powders, particles, extrudates, pellets, films, coatings, fibers, and the like, each of which can have a variety of end uses such as use in fuel cell electrodes, as electrode catalysts, as catalysts for chemical reactions, e.g., hydrogenation or dehydrogenation, oxidation, isomerization, reforming, hydrocracking, polymerization, etc. Use of the compositions in proton exchange membrane fuel cells (PEMFCs) or direct methanol fuel cells (DMFCs) as electrode catalysts is especially preferred.

For use as PEM electrode catalysts, the above-described aerogel/metallic compositions are incorporated as electrodes into membrane structures to define membrane electrode assemblies. Typically, the membrane is a polymer electrolyte that is capable of providing the proper ionic conductivity between the opposingly positioned electrodes. One exemplary polymer electrolyte is a perfluorosulfonated ionomer (e.g., unagglomerated polyfluorosulphone (Nafion®, available from E. I. duPont de Nemours and Company, Wilmington, Del.)) as a 5% solution of perfluorosulfonic acid/PTFE copolymer in protonic form. Other suitable polymers include, but are not limited to, tetrafluoroethylene-fluorovinyl ether copolymers having at least one acidic group, sulfonated polyether ketones, aryl ketones, polybenzimidazoles, polysulfone, polyestersulfone, polystyrenesulfonic acid, polyvinylidene fluoride, and combinations of the foregoing. In any embodiment, the polymer may be reinforced. Because the ability of a catalyst to effect an electrochemical reaction across an electrolyte is a function of the amount of surface area of the catalyst material in contact with the electrolyte, contact made between the catalyst and the electrolyte provides the mechanism by which an oxidation-reduction occurs between the catalyst and the electrolyte.

Referring to FIG. 3, a fuel cell is shown generally at 30. The fuel cell 30 comprises an MEA 32 mounted between flow plates 34, each of which may be configured to provide for the flow of fluid to and from the MEA 32. The MEA 32 comprises a solid electrolyte membrane such as a proton-conducting substrate 40 on which is disposed an anode catalyst layer 42 and a cathode catalyst layer 44. Diffusion media 36 (e.g., conductive carbon paper, carbon cloth, or other carbon electrically conductive material) are mounted intermediate the MEA 32 and the facing surfaces of each flow plate 34, thereby facilitating fluid communication of the hydrogen gas between the flow channel and the anode catalyst layer, and further facilitating fluid communication of the oxygen gas and the resultant water vapor between the cathode flow channel and the cathode catalyst layer. Sealing gaskets 37 (e.g., polytetrafluoroethylene masks) may be mounted intermediate the MEA 32 and each flow plate 34.

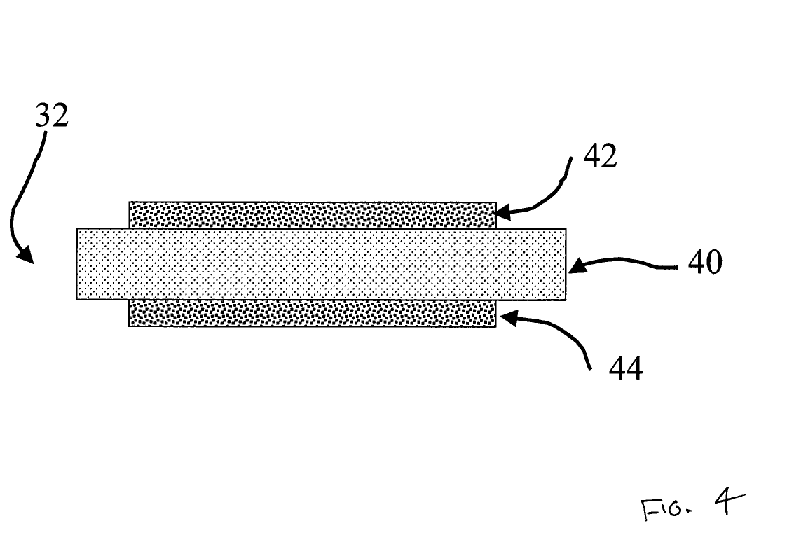

Referring now to FIG. 4, the MEA 32 is shown in detail. As is stated above, the MEA 32 comprises the proton-conducting substrate 40 on which the carbon supported catalyst is deposited to form the anode catalyst layer 42 and the cathode catalyst layer 44.

In this exemplification, the carbon supported catalyst comprises platinum or another catalytic metal(s) supported by a carbon aerogel. The proton-conducting substrate 40 is preferably a substrate of the polymer electrolyte (e.g., perfluorosulfonated ionomer, as indicated above) having the suitable degree of ionic conductivity sufficient to facilitate the proton communication therethrough.

The carbon supported catalyst preferably comprises the carbon aerogel as described above having platinum or other catalytic metals in alloy-form or pure crystalline-form dispersed therein. The pore size of the carbon aerogel utilized as a catalyst support is regulated during its synthesis by the amounts and ratios of reactants and catalyst as well as the reaction conditions. Preferably, the amounts and ratios of reactants and the reaction conditions are regulated to result in a mesoporous carbon aerogel having a surface area of greater than about 600 m²/g and preferably more than about 700 m²/g. The term “mesoporous” is intended to indicate a pore size of about 2 nm to about 50 nm. Preferred pore sizes are greater than about 4 nm and more preferably greater than about 15 nm for the cathode catalyst layer.

The platinum is preferably impregnated onto the carbon aerogel support in the presence of carbon dioxide at supercritical conditions. The amount of platinum dispersed onto the support is controlled by the addition of a preselected amount of platinum precursor to a vessel in which the dispersion occurs. The dispersion rate, which is calculated by the ratio of catalytically active atoms to the total catalyst atoms dispersed in the catalyst, is about 35%, preferably about 50%, more preferably about 70%, and even more preferably about 90%. The platinum (or other metal) used has a chemically active surface area that is greater than about 80 m²/g, preferably greater than 100 m²/g, more preferably greater than 150 m²/g, even more preferably greater than about 200 m²/g, and even more preferably about 250 m²/g. The total amount of platinum deposited may be limited by the equilibrium of adsorption and desorption of precursor onto the carbon aerogel in carbon dioxide at supercritical conditions. One exemplary condition under which the carbon dioxide may be deposited is a temperature of 80 degrees C. for 24 hours. The resultant catalyst layer consisting of platinum catalyst and perfluorosulfonated ionomer has a glass transition temperature of about 110 degrees C. to about 130 degrees C. and preferably about 110 degrees C. to about 120 degrees C.

Also in this embodiment, the micro-sized catalyst powder made of ground carbon aerogel is homogenized with the unagglomerated polyfluorosulphone electrolyte (e.g. Nafion®) solution and combined with a binder to prepare catalytic paste, slurry, or ink.

The deposition of the catalysts onto substrates to form MEAs comprises preparing the compositions as inks (or slurries, pastes, or the like), transferring the inks onto transfer mediums (e.g., decals or the like), and/or transferring the inks onto the appropriate membrane surfaces or gas diffusion layer. In a preferred method, a screen printing technique is used to dispose the catalysts onto the transfer mediums, and a decal transfer mechanism is used to transfer the screen printed catalytic electrodes to the membrane surfaces to define the anode and the cathode.

In particular, the catalyst powder (the platinum or other catalytic metal laden aerogel) is preferably deposited onto the transfer medium as indicated above and transferred from the medium onto the proton-conducting substrate. The thickness to which the catalyst paste, slurry, or ink is deposited onto the medium is less than about 100 micrometers (um), preferably less than about 20 um, and more preferably less than about 10 um.

To form the catalyst powder as an ink, porous aerogel supported catalyst material and electrolyte material are ground and homogenized in an aqueous solution. Grinding of the aerogel supported catalyst material is effectively achieved using any suitable means. If the catalyst material is ground by hand, an agate mortar and pestle are preferred. Homogenization of the resulting solution may also be achieved by any suitable means.

For the cathode, carbon aerogel supported catalyst having a platinum loading of about 10 wt. % platinum to about 60 wt. % platinum and an average pore size of about 10 nm to about 50 nm is mixed in an inert atmosphere with water, the proton conductive polymer or composite material electrolyte, and at least one solvent to form the ink having an electrolyte content of about 5 wt. %. The solvent may be a diol. Plasticizers may be incorporated into the ink, and the ink may be re-homogenized after the addition of any ingredient. The final viscosity of the ink is adjusted to a predetermined value.

The ink is then deposited onto inert polymer films to form decals. Each film has at least one surface that has a low coefficient of adhesion. The ink is deposited onto one low-adhesion surface of the film by any suitable method. A polyester screen may be used for the deposition of ultrathin catalyst layers onto the surface of the film. Other means of depositing the ink onto the film include, but are not limited to, spraying, spin-coating, micro-gravure, combinations of the foregoing methods, and the like. The film having the ink deposited thereon is the finished decal.

The catalyst may be deposited as a single-layer structure or as a multiple-layer structure. If the catalyst is a multiple-layer structure, adjacently-positioned layers may have either the same or different compositions of proton conducting polymer or composite material.

Following the deposition of the ink onto the decal, the decal is placed on the membrane such that the deposited ink contacts the surface of the membrane. The exposed surfaces of the decal are then hot-pressed to cause or at least facilitate the transfer of the ink to the membrane surface. Hot-pressing of the decal is effected by applying a hot surface against the exposed surface of the decal for a period of time of about 1 to 15 minutes and more preferably about 3 to 5 minutes. The temperature at which each decal is hot-pressed is at or above the glass transition temperature of the corresponding electrolyte.

Once hot-pressed, the membrane is cooled or allowed to cool to room temperature (about 12 degrees C. to about 30 degrees C. and preferably about 15 degrees C. to about 25 degrees C.) and the decals are removed from the membrane leaving the corresponding microstructured catalyst layers disposed on the membrane as the anode and cathode. Preferably, the decal is physically removed from the surface of the membrane, for example, by peeling. It is also preferable that no catalyst remains on the surface of the decal after the hot-pressing procedure.

### EXAMPLE 1

### Characterization of Aerogel Supported Platinum Catalysts

Aerogel supported platinum catalysts have been provided for subsequent use in the manufacture of cathode catalyst layers for fuel cell applications. Two catalysts that differ in platinum content and porosity were analyzed. The results of each catalyst are presented below in Table 1.

TABLE 1
Physical characteristics of catalyst samples

| Sample | Platinum content (%) | Porosity (nm) |
|---|---|---|
| 1 | 37 | 16 |
| 2 | 20 | 22 |

The porosity was estimated using the Brunauer-Emmett-Teller (BET) method. In the BET method, adsorption and desorption isotherms of nitrogen were measured using a gas adsorption analyzer (Sorptomatic 1990, available from Horiba). Mesopore size distributions and mesopore volumes were estimated for pore diameters of 2 nm to 50 nm by applying the Dollimore-Heal method to the desorption isotherm of nitrogen.

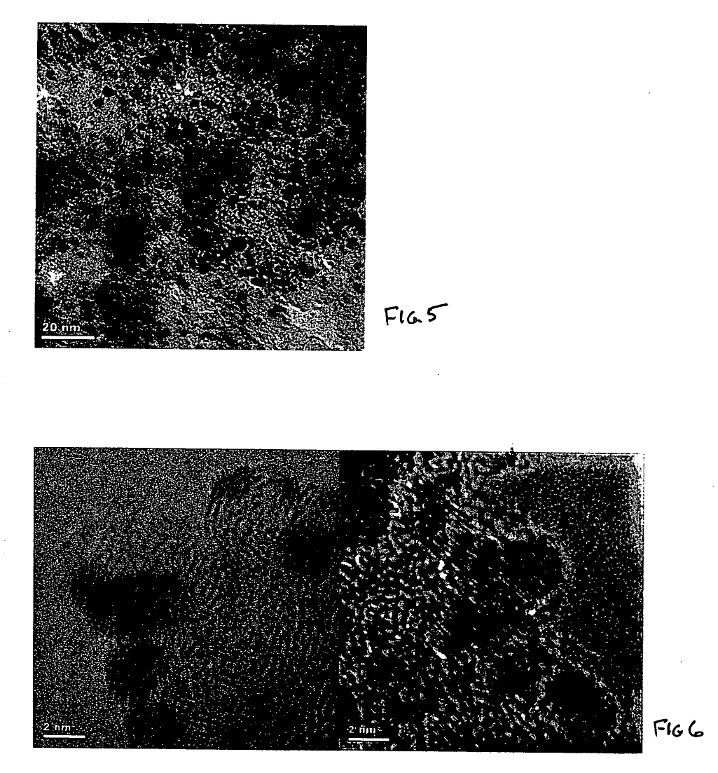

The mean diameter and the surface area of the platinum particles were measured by hydrogen adsorption. High resolution transmission electronic microscopy TEM was used for the estimation of platinum particle size in the aerogel supported platinum samples. Referring to FIG. 5, an even distribution of platinum particles on the surface of the carbon support can be seen. The particle size is about 2 nm, which is in correlation with the BET analysis data. High resolution TEM images, as are shown in FIG. 6, indicate similarity in the structure of the support and in the size of the platinum particles for both samples. The left side of FIG. 6 shows the catalyst in Nafion® solution, and the right side of FIG. 6 shows the catalyst in a dry state.

The aerogel supported platinum catalyst with and without perfluorosulfonated ionomer was deposited on metal grids covered with carbon foil in which circular holes of about 1.2 um were disposed. The metal grids were gold Quantifoil grids. TEM analyses were performed with a transmission electron microscope (Philips EM420 TEM equipped with a Kevex-Noran Beryllium Window EDS system) operating at an accelerating voltage of 100 kilovolts (kV). High-resolution TEM lattice images were obtained. The mean particle size was obtained by measuring the diameter of a sufficient number of particles to ensure a good statistic.

### EXAMPLE 2

### Preparation of Catalyst Paste and MEA

For anodes (reference electrodes), porous carbon aerogel supported catalysts from Tanaka Kikinzoku Kogyo (TKK) having metal contents of about 53.5% metal were mixed in nitrogen atmospheres with water, 5 wt. % Nafion® solutions, and appropriate solvents. The prepared mixtures were homogenized using an Ultra-Terrux homogenizer with further evaporation of the excess amount of the solvent to obtain the appropriate viscosity.

Cathode aerogel supported catalysts having different platinum loadings and pore size distributions received as rods from Aerogel Composite, LLC, were ground in an agate mortar and subsequently prepared as inks by the above-mentioned process.

Polytetrafluoroethylene film, which is available as Teflon® from E. I. duPont de Nemours and Company, Wilmington, Del., was used as decals for the application of the anodes and cathode. The films were weighed before the application of the catalyst inks. The inks were then screen printed onto the films using an automated screen printing system (Model 810 Series from Systematic Automation). A polyester screen from SAATI Print was used for the deposition of ultrathin catalyst layers onto the surface of the Teflon® films.

To form the MEA, the decals were placed on either side of Nafion® 112 or Nafion® 117 membranes purchased from DuPont. After drying and hot pressing at 70 kilograms per centimeter squared (kg/cm²) for 5 minutes, the Teflon® supported films were peeled away from the cathode and anode sides of the MEAs.

Further experiments were undertaken in the hardware with 6.25 cm² active areas from ElectroChem, Inc. The cells included gas diffusion layers from SGL Technologies GmbH and Teflon gaskets having thicknesses of 0.25 millimeters (mm), which correspond to a total pinch of 0.2 mm.

### EXAMPLE 3

### Measurement of Platinum Particle Surface Area

The measurements of platinum surface area in contact with the perfluorosulfonated ionomer surface area and thus available for electrochemical reaction were made using a cyclic voltammetry (CV) technique in a four-point probe configuration. The use of cyclic voltammetry was used to determine the amount of hydrogen crossing over the membrane that was oxidized. Cyclic voltammetry plots were obtained in the range of 0.01 to 0.8 volts (V) at a scan rate of 20 millivolts per second (mV/sec) at room temperature (about 23 degrees C. to about 27 degrees C.) using a potentiostat (Princeton potentiostat Model 273). To avoid the presence of oxygen, pure nitrogen was supplied to the cathode side (the working electrode) of an MEA and pure hydrogen was supplied to the anode side (the counter electrode) of the MEA at a flow rate of 200 cubic centimeters per minute (cc/min).

An estimation of the electrochemical surface area (ESA) of the catalyst was estimated from CV plots using the equation A_{ESA}=A/(K*L*S) where A is the area under the reduction portion of the curve between the current density corresponding to a double layer capacitance at the lowest voltage and the second inflection point indicating the beginning of hydrogen evolution from the surface of the platinum, K is 0.21 milliamperes per centimeter squared (mA/cm²), L is the platinum loading in the cathode catalyst layer in milligrams per centimeter squared (mg/cm²), and S is the scan rate of the instrument (which corresponds to 20 mV/sec).

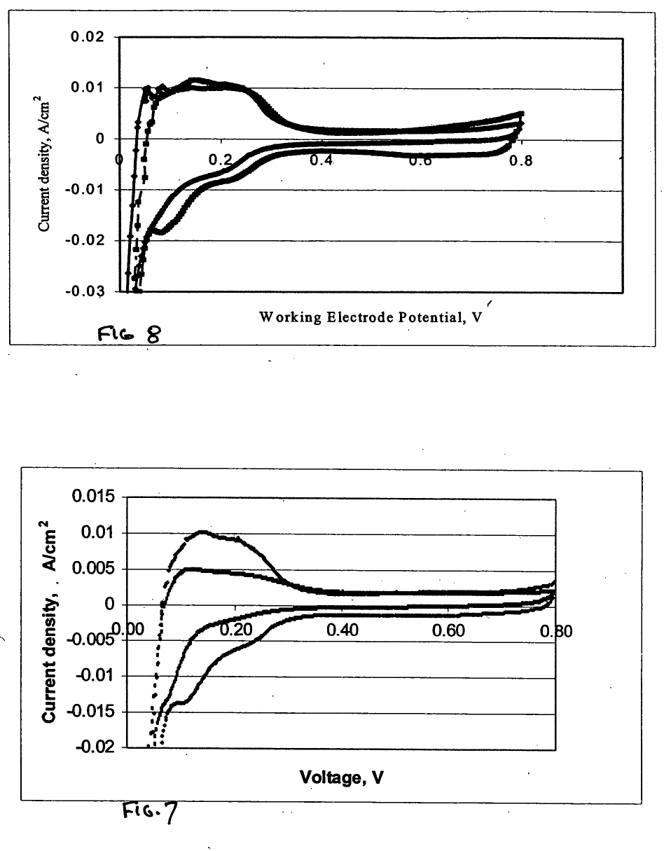

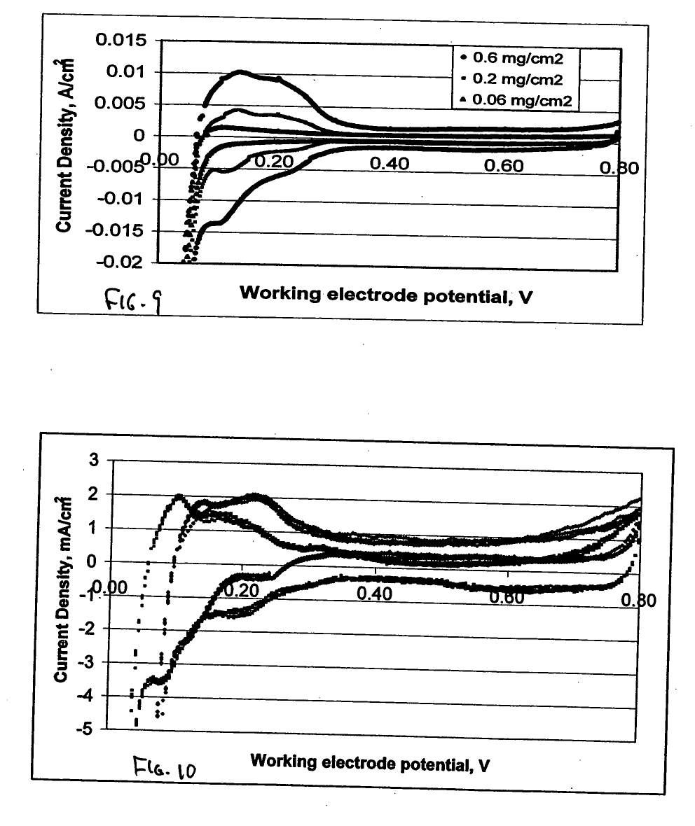

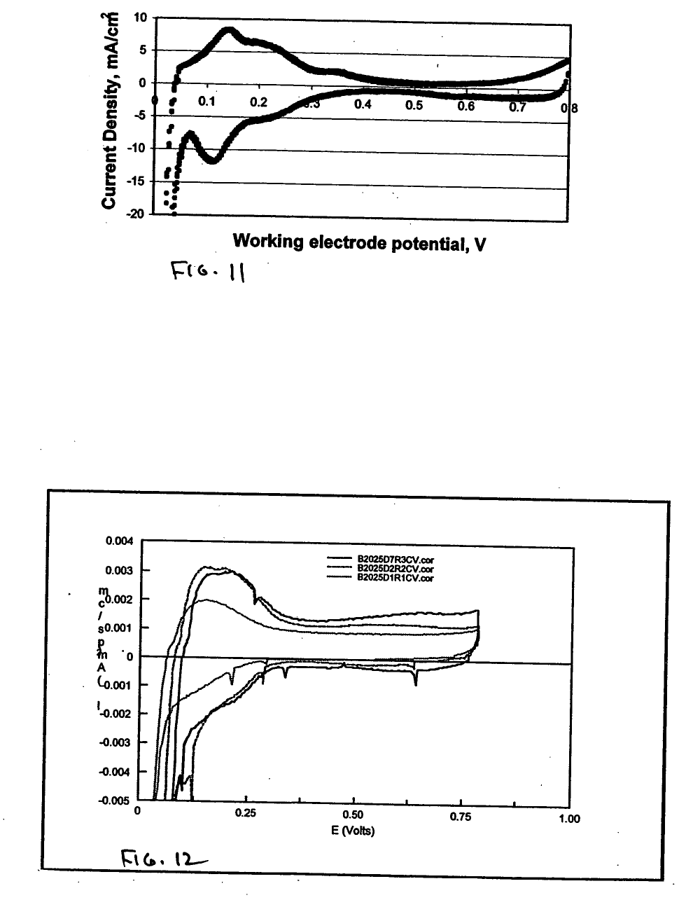

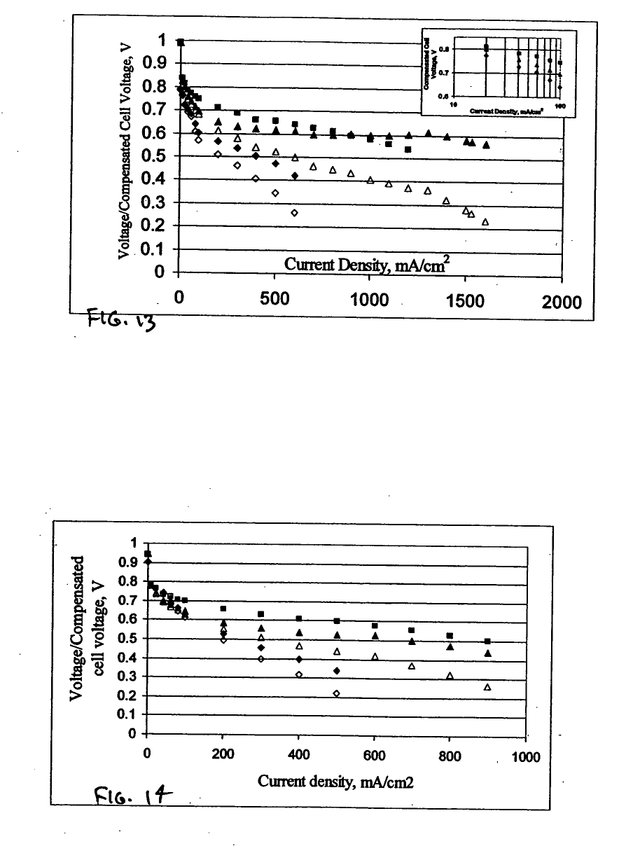

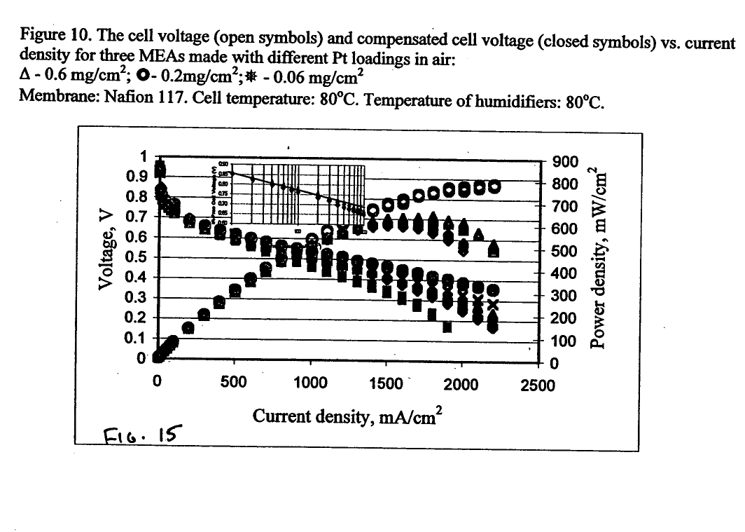

The estimation of the ESA of the catalyst was made before, between, and after measurements relating to the performance of a fuel cell were made. As is illustrated in FIG. 7, the ESA in both of the aerogel supported platinum catalysts (with 25 wt. % Nafion® before and after humidification, platinum loading 0.6 mg/cm², and in which the calculated value of the ESA before and after humidification corresponds to 41 m²/g and 71 m²/g, respectively) increased by more than 100% after a few hours of testing. This effect, however, was much less pronounced in the case of commercially-available supported and unsupported catalysts, as can be seen in FIGS. 8 and 9. There, the corresponding changes in ESA were less than 10%. After humidification of the cell at 80 degrees C., contact between the electrolyte molecules and platinum particles is enhanced, as Nafion® increases in volume and is able to maintain better contact with platinum particles distributed on the internal surfaces of the aerogel pores. This can be seen in FIG. 10, in which CV plots for aerogel-supported platinum catalysts at different catalyst loadings are shown.

Comparative data for the commercially-available carbon supported platinum catalysts under similar platinum loadings and the same Nafion content, as is indicated in FIG. 11, indicates lower values for the ESA.

Catalyst stability under cell environments was estimated by comparison of the ESA values after certain periods of cell testing. Referring to FIG. 12, data for aerogel-supported catalysts on the first day, after humidification, and after 60 hours is shown.

### EXAMPLE 4

### Fuel Cell Testing Procedure

In order to assess the performance of the catalyst, a fuel cell was incorporated into a Teledyne test station and operated under gas flow conditions in order to simulate the operation of a fuel cell under actual field conditions. Various operating parameters were monitored (e.g., temperature, gas flow stochiometry, power output, efficiency, and the like).

### EXAMPLE 5

### Evaluation of Catalyst Stability

Data indicating the stabilities of various catalysts were obtained after exposure of the catalysts to fuel cell environments. These stabilities were estimated by comparing the ESAs after specified periods of cell testing. Referring to FIG. 13, data is shown for two aerogel-supported catalysts after one day, after humidification, and after 60 hours. The corresponding data of calculated ESA values for the second sample is equal to about 99 meters squared per gram (m²/g), which is about 25% greater than the value for the first sample.

### EXAMPLE 6

### Influence of Platinum Loading on Cell Performance

The aerogel supported platinum catalyst for oxygen reduction in a cathode catalyst layer was tested in a PEM fuel cell having a similar membrane and anode composition. The performances of the cells with different loadings of platinum in air are shown in FIG. 14.

### EXAMPLE 7

### Influence of Reduced Platinum Content in Aerogel Support

A catalyst having a platinum loading of about 0.1 mg/cm² was evaluated for fuel cell performance. As is shown in FIG. 15, the performance of the PEMFC fuel cell with aerogel supported platinum catalyst is graphically represented with a platinum loading of 0.1 mg/cm² at different operating conditions in an air/hydrogen mixture.

Each point is the average of 20 readings taken every 15 seconds during 5 minute intervals at the different current densities. The performance was evaluated at 40, 60, and 80 degrees C. and at hydrogen and oxygen flow rate ratios corresponding to 1:2.5 and 1:10 stoichiometry. At lower current densities, the cell demonstrated close to theoretical values of Tafel slopes (about 78 mV/decade) in the kinetically controlled region of current densities. In this range, the commercial catalyst demonstrated similar values of OCV and Tafel slope.

It can be seen that the highest power density did not increase linearly with a corresponding increase in the cell temperature. Accordingly, the maximum values were observed at 60 degrees C. At higher flow rates, the corresponding power densities were about 0.8 milliWafts per centimeter squared (mW/cm²) at 2,300 milliamperes per centimeter squared (mA/cm²).

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1. A process of manufacturing a membrane electrode assembly, said process comprising the steps of:
preparing an electrode-forming catalyst ink comprising porous carbon aerogel supported catalyst and one or more electrolytes;
depositing the prepared catalyst ink on a polymer film to form one or more catalyst layers;
hot-pressing said one or more catalyst layers deposited on said polymer film at a temperature that is higher than a glass transition temperature of said electrolyte against a membrane;
decreasing the temperature of said hot-pressed catalyst layer and said polymer film; and
removing said polymer film from said one or more catalyst layers.

2. The process of claim 1, wherein said step of preparing said electrode-forming catalyst ink comprises,
grinding said porous carbon aerogel supported catalyst and said electrolyte, and
homogenizing said porous carbon aerogel supported catalyst and said electrolyte in an aqueous solution.

3. The process of claim 1, wherein said catalyst layer comprises at least one noble metal.

4. The process of claim 3, wherein said at least one noble metal comprises a transition metal.

5. The process of claim 1, wherein said step of depositing the prepared catalyst ink on said polymer film is effected by screen printing said prepared catalyst ink, spraying said prepared catalyst ink, micro-gravure deposition, sputtering, spin-coating said prepared catalyst ink, or a combination thereof on said polymer film.

6. The process of claim 1, wherein said step of preparing said electrode-forming catalyst ink comprises mixing said aerogel supported catalyst and said electrolyte with at least one plasticizer.

7. The process of claim 6, wherein said step of preparing said electrode-forming catalyst ink comprises mixing said aerogel supported catalyst and said electrolyte with said at least one plasticizer in an inert atmosphere.

8. The process of claim 7, wherein said step of preparing said electrode-forming catalyst ink further comprises mixing said porous aerogel supported catalyst and said electrolyte in a solvent.

9. The process of claim 7, wherein said step of preparing said electrode-forming catalyst ink further comprises re-homogenizing said porous aerogel supported catalyst and said electrolyte.

10. The process of claim 1, wherein said catalyst layer comprises a single-layer structure.

11. The process of claim 1, wherein said catalyst layer comprises a multiple-layer structure in which adjacently-positioned layers thereof have the same compositions.

12. The process of claim 1, wherein said catalyst layer comprises a multiple-layer structure in which adjacently-positioned layers thereof have different compositions.

13 . The process of claim 1, further comprising a step of leaving a residual amount of high boiling point solvent in said catalyst ink before said hot-pressing.

14. A process of preparing a membrane electrode assembly for use in a fuel cell, said process comprising the steps of:
preparing a decal having a catalyst ink deposited thereon; and
transferring said catalyst ink from said decal to a membrane of said membrane electrode assembly to form an electrode.

15. The process of claim 14, wherein said preparing said decal comprises depositing said catalyst ink on a polymer film.

16. The process of claim 14, wherein said transferring said catalyst ink comprises,
placing said decal on said membrane, and
hot-pressing said decal against said membrane.

17. The process of claim 16, further comprising removing an inert backing sheet of said decal.

18. A process of preparing an electrode-forming catalyst ink for use in a membrane electrode assembly of a fuel cell, said process comprising the steps of:
grinding a porous carbon aerogel having a metal disposed thereon;
grinding an electrolyte material; and
homogenizing said ground porous carbon aerogel and said ground electrolyte material.

19. The process of claim 18, further comprising applying said electrode-forming catalyst ink to an inert polymer film.

20. The process of claim 19, wherein said applying said electrode-forming catalyst ink comprises screen printing said ink onto said inert polymer film, spraying said ink onto said inert polymer film, depositing said ink onto said inert polymer film using a micro-gravure technique, sputtering said ink onto said inert polymer film, spin-coating said ink onto said inert polymer film, or a combination thereof.
